(19) United States
(12) Patent Application Publication
(10) Pub. No.: US 2009/0135151 A1
(43) Pub. Date: May 28, 2009

(54) HIGH TRANSMITTANCE TOUCH PANEL

(75) Inventor: Jeng-Hung Sun, Hsinchu City (TW)

Correspondence Address: MERCHANT & GOULD PC, P.O. BOX 2903, MINNEAPOLIS, MN, 55402-0903, US

(73) Assignee: ACROSENSE TECHNOLOGY CO., LTD., Annan District (TW)

(21) Appl. No.: 12/275,730

(22) Filed: Nov. 21, 2008

(30) Foreign Application Priority Data
Nov. 23, 2007 (TW) 096144535

(51) Int. Cl. G06F 3/041

(52) U.S. Cl. 345/173

(57) ABSTRACT

A touch panel includes: a transparent substrate; and a transparent multi-layered structure disposed on the substrate and including transparent inner and outer anti-reflection layers and a transparent touch control layer that is sandwiched between the inner and outer anti-reflection layers and that is made from an electrically conductive material. The inner anti-reflection layer has an anti-reflection film. At least one of the outer anti-reflection layer and the anti-reflection film has an optical thickness sufficient for generating destructive interference among reflections from the substrate, the outer anti-reflection layer, the anti-reflection film, and the touch control layer.

### CROSS-REFERENCE TO RELATED APPLICATION

This application claims priority of Taiwanese Application No. 096144535, filed on Nov. 23, 2007.

### BACKGROUND OF THE INVENTION

1. Field of the Invention

This invention relates to a high transmittance touch panel, more particularly to a high transmittance touch panel including at least one anti-reflection layer having an optical thickness equal to or less than a quarter wavelength of visible light.

2. Description of the Related Art

Touch panels are mounted on a screen of an electronic device and are transparent so as to permit the user to touch icons or command signs shown on the screen to perform desired functions. Applicant found that when design a touch panel having transparent conductive bodies of a transparent material, such as indium tin oxide (ITO), on a transparent substrate for serving as touch sensors for performing certain functions, there was a clarity problem that the conductive bodies were visible to the naked eye due to a relatively low transmittance or a relatively high reflectance thereof. Therefore, the touch panel thus formed will be undesirably formed into regions of a higher transmittance (free of the conductive bodies) and regions of a lower transmittance (having the conductive bodies), which will result in a non-uniform transmittance and an adverse effect on the display quality, such as clarity, of the screen of the electronic device.

### SUMMARY OF THE INVENTION

Therefore, the object of the present invention is to provide a high transmittance touch panel that can eliminate the aforesaid problems with respect to the non-uniform transmittance and clarity of the screen of the electronic device.

According to this invention, there is provided a high transmittance touch panel that comprises: a transparent substrate; and a transparent multi-layered structure disposed on the substrate and including transparent inner and outer anti-reflection layers and a transparent touch control layer that is sandwiched between the inner and outer anti-reflection layers and that is made from an electrically conductive material. The inner anti-reflection layer has an anti-reflection film. At least one of the outer anti-reflection layer and the anti-reflection film has an optical thickness sufficient for generating destructive interference among reflections from the substrate, the outer anti-reflection layer, the anti-reflection film, and the touch control layer.

### BRIEF DESCRIPTION OF THE DRAWING

Other features and advantages of the present invention will become apparent in the following detailed description of the preferred embodiments of this invention, with reference to the accompanying drawings, in which:

FIG. 1 is a cutaway perspective view of the first preferred embodiment of a touch panel for a screen of an electronic device according to this invention;

FIG. 2 is a fragmentary schematic top view of the first preferred embodiment;

FIG. 3 is a fragmentary sectional view of the first preferred embodiment;

FIG. 4 is a plot of the transmittance of the first preferred embodiment for a wavelength range of visible light;

FIG. 5 is a schematic top view of the second preferred embodiment of the touch panel according to this invention;

FIG. 6 is a fragmentary sectional view of the second preferred embodiment;

FIG. 7 is a fragmentary sectional view of the third preferred embodiment of the touch panel according to this invention; and

FIG. 8 is a fragmentary sectional view of the fourth preferred embodiment of the touch panel according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

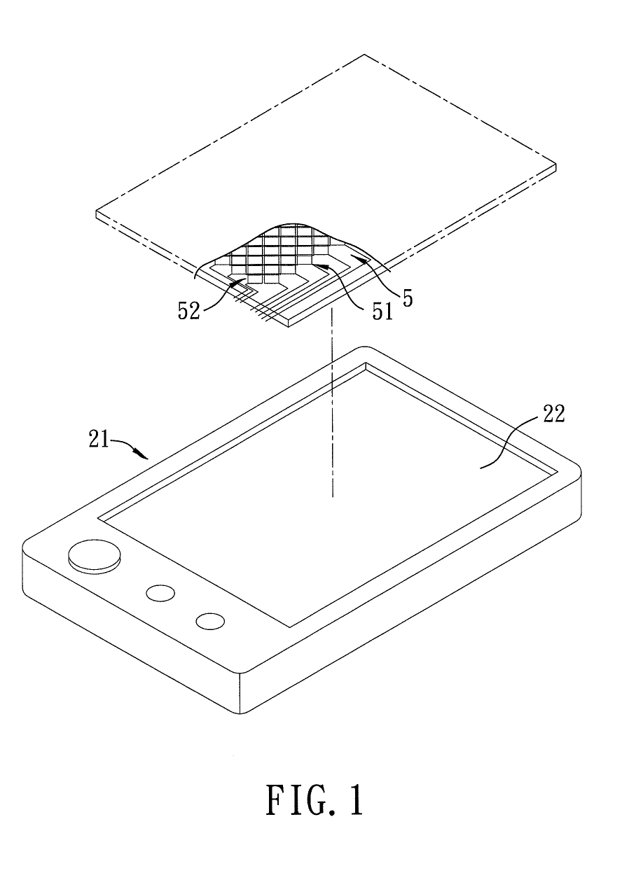

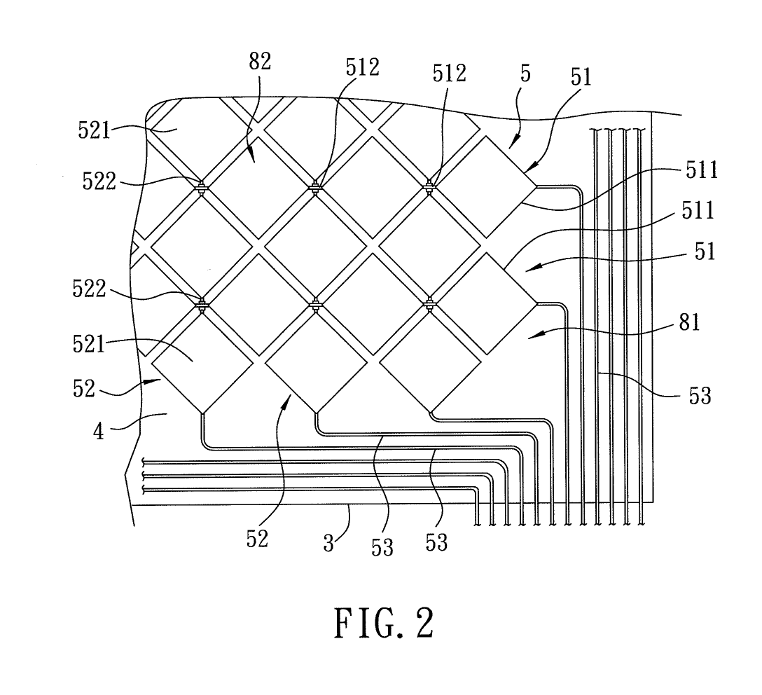

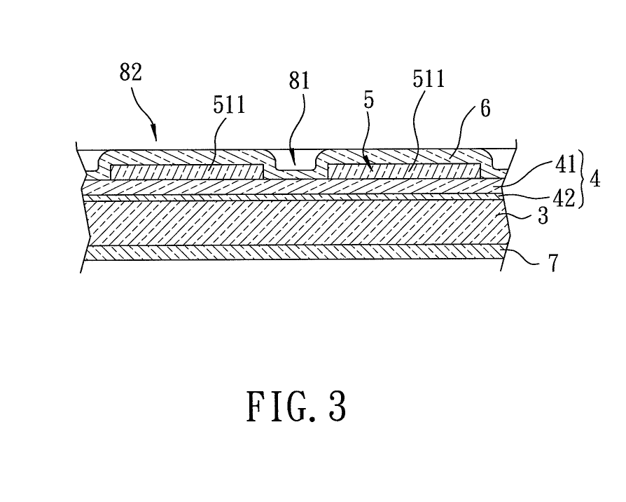

FIGS. 1 to 3 illustrate the first preferred embodiment of a high transmittance touch panel for mounting on a screen 22 of an electronic device 21 according to this invention. The touch panel includes: a transparent substrate 3; and a transparent multi-layered structure disposed on the substrate 3 and including transparent inner and outer anti-reflection layers 4, 6 and a transparent touch control layer 5 that is sandwiched between the inner and outer anti-reflection layers 4, 6 and that is made from an electrically conductive material. The touch control layer 5 is formed directly on the outer anti-reflection layer 6. The inner anti-reflection layer 4 has a first anti-reflection film 41 formed directly on the touch control layer 5. At least one of the outer anti-reflection layer 6 and the first anti-reflection film 41 has an optical thickness (nd) (i.e., the product of refractive index (n) and film thickness (d)) sufficient for generating destructive interference among reflections from the substrate 3, the outer anti-reflection layer 6, the first anti-reflection film 41, and the touch control layer 5. The destructive interference thus formed causes reflections from the touch control layer 5 to interfere destructively with reflections from at least one of the substrate 3, the outer anti-reflection layer 6, and the first anti-reflection film 41.

In this embodiment, the inner anti-reflection layer 4 further has a second anti-reflection film 42 sandwiched between the first anti-reflection film 41 and the substrate 3. A conductive grounding layer 7 is disposed on one side of the substrate 3 opposite to the multi-layered structure.

The substrate 3 may be made from materials, such as glass, polymethylmethacrylate (PMMA), polyvinylchloride (PVC), polypropylene (PP), polyethylene terephthalate (PET), polyethylene naphthalate (PEN), and polycarbonate (PC). Preferably, the substrate 3 is made from glass that has a refractive index of about 1.52.

Preferably, the first and second anti-reflection films 41, 42 have an optical thickness (nd) not greater than λ/4, where λ is the wavelength of visible light. More preferably, the optical thickness of the first anti-reflection film 41 is equal to or slightly less than λ/4.

Preferably, the first and second anti-reflection films 41, 42 are made from a metal oxide, a metal fluoride, a metal carbide, a metal nitride, silicon oxide, silicon nitride, silicon carbide, or combinations thereof.

Preferably, the first anti-reflection film 41 has a refractive index not greater than that of the substrate 3, and the second anti-reflection film 42 has a refractive index greater than that of the substrate 3. In one preferred embodiment, the substrate 3 is made from glass, the first anti-reflection film 41 has a film thickness of 80 nm and is made from silicon oxide (SiO₂) that has a refractive index ranging from about 1.45 to 1.5, and the second anti-reflection film 42 has a film thickness of 30 nm and is made from Titanium oxide (TiO₂) that has a refractive index of about 2.3. Note that the inner anti-reflection layer 4 may include only one anti-reflection film or more than two of the anti-reflection films based on actual requirements.

In this embodiment, the touch control layer 5 includes a plurality of parallel rows 51 of first electrodes 511 that are spaced apart from each other, a plurality of columns 52 of second electrodes 521 that are spaced apart from each other, and a plurality of connecting lines 53 extending respectively from the first and second electrodes 511, 521 for external connection to a controller (not shown). The first and second electrodes 511, 521 and the connecting lines 53 are preferably made from a transparent conductive material, such as indium-tin-oxide (ITO), indium-zinc-oxide (IZO), aluminum zinc oxide (AZO), and combinations thereof, and are more preferably made from ITO. The touch control layer 5 further includes a plurality of conductive first interconnecting lines 512, each of which interconnects two adjacent ones of the first electrodes 511, and a plurality of conductive second interconnecting lines 522, each of which interconnects two adjacent ones of the second electrodes 521 and intersects insulatively an adjacent one of the first interconnecting lines 512.

Each of the second electrodes 521 is operatively associated with at least an adjacent one of the first electrodes 511 to define a capacitor therebetween so that when the user approaches or touches a location of the screen 22, the electric field at the location is changed, which results in a change in the capacitance between the first and second electrodes 511, 512 at the location, thereby permitting identification of the coordinates of the location through the controller. Note that the layer thickness of the touch control layer 5 is not uniform in this embodiment, and has a maximum layer thickness of less than 2 microns.

Preferably, the outer anti-reflection layer 6 is made from a metal oxide, a metal fluoride, a metal carbide, a metal nitride, or silicon oxide, and has a refractive index not greater than that of the substrate 3, and an optical thickness approximately or equal to λ/4. In one preferred embodiment, the outer anti-reflection layer 6 has a layer thickness of 80 nm, and is made from silicon oxide (SiO₂) having a refractive index ranging from 1.45 to 1.5.

Preferably, the grounding layer 7 is made from a transparent conductive material, such as indium-tin-oxide (ITO), indium-zinc-oxide (IZO), aluminum zinc oxide (AZO), and combinations thereof. The grounding layer 7 serves as an electromagnetic shield for preventing external electromagnetic waves from interfering with the operation of the touch control layer 5.

Due to the presence of the touch control layer 5, the multi-layered structure can define a plurality of first regions 81, each of which includes a portion of the inner anti-reflection layer 4 and a portion of the outer anti-reflection layer 6 that covers said portion of the inner anti-reflection layer 4. The multi-layered structure can further define a plurality of second regions 82, each of which includes another portion of the inner anti-reflection layer 4, a respective one of the first and second electrodes 511, 521 that covers said another portion of the inner anti-reflection layer 4, and another portion of the outer anti-reflection layer 6 that covers said one of the first and second electrodes 511, 521. By having the optical thicknesses of the outer anti-reflection layer 6 and the first anti-reflection film 41 to be equal to or approximately λ/4, the touch panel of this invention can generate a destructive interference such that the reflections from the touch control layer 5 can interfere destructively with reflections from at least one of the substrate 3, the outer anti-reflection layer 6, and the first anti-reflection film 41, thereby considerably reducing the difference in the transmittance between the first regions 81 and the second regions 82, and thereby enhancing the uniformity of the transmittance and thus the clarity of the touch panel.

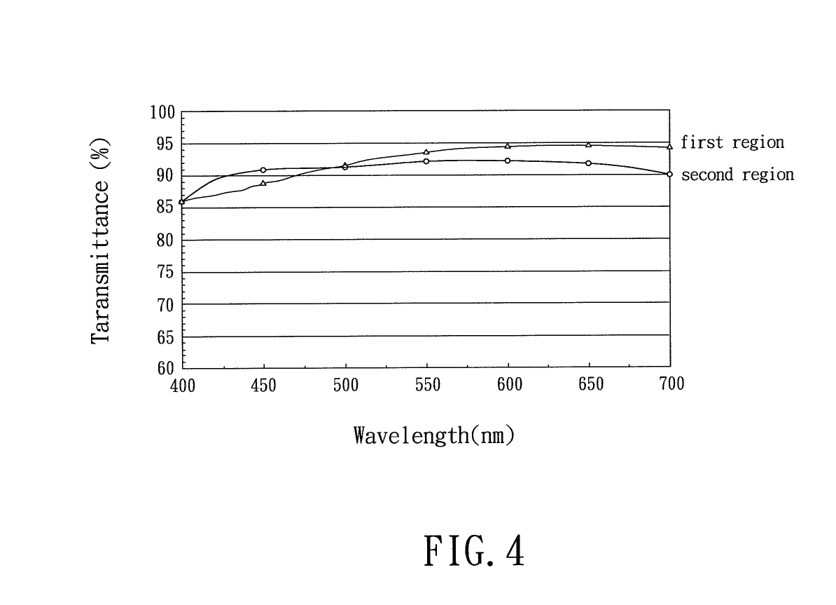

FIG. 4 is a plot showing the difference in the transmittance between the first and second regions 81, 82 for visible light with a wavelength ranging from 400 nm to 700 nm. The results show that the difference in the transmittance is less than 5% for the wavelength range of from 400 nm to 700 nm. At this level of the difference, the first and second regions 81, 82 cannot be distinguished from each other through the naked eye. In addition, the difference in the transmittance is less than 1% for the first and second regions 81, 82 (which are 93% and 92%, respectively) at 550 nm wavelength (which is a green light and to which the human eye is most sensitive).

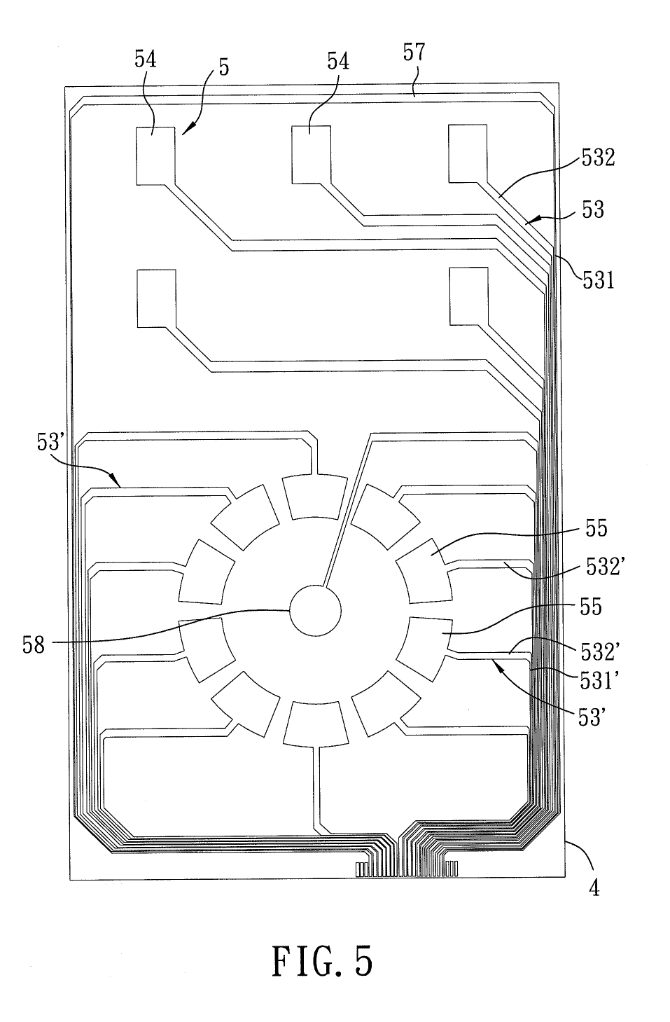

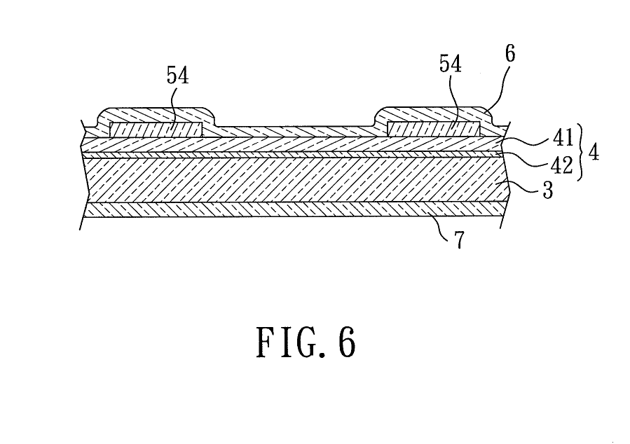

FIGS. 5 and 6 illustrate the second preferred embodiment of the touch panel for mounting on a screen of another type of an electronic device (not shown) according to this invention. The second preferred embodiment differs from the previous embodiment in the structure of the touch control layer 5. In this embodiment, the touch control layer 5 includes a plurality of spaced apart conductive first functional key pads 54, and a reference potential strip 57 associated operatively with each of the conductive first functional key pads 54 so as to establish a charge difference therebetween. Note that the reference potential strip 57 and the first functional key pads 54 are also electrodes, respectively. The touch control layer 5 further includes a plurality of conductive second functional key pads 55 (such as for controlling sound volume or screen brightness) angularly displaced from one another, and a central pad 58 surrounded by the second functional key pads 55. The reference potential strip 57 is operatively associated with each of the second functional key pads 55 and the central pad 58 so as to establish a charge difference therebetween. The touch control layer 5 further includes a plurality of first connecting lines 53, each of which extends from a respective one of the first functional key pads 54, and a plurality of second connecting lines 53′, each of which extends from a respective one of the second functional key pads 55. The first and second connecting lines 53, 53′ are adapted to be connected to a controller (not shown). Note that the first and second functional key pads 54, 55, the reference potential strip 57, and the central pad 58 are also electrodes, respectively.

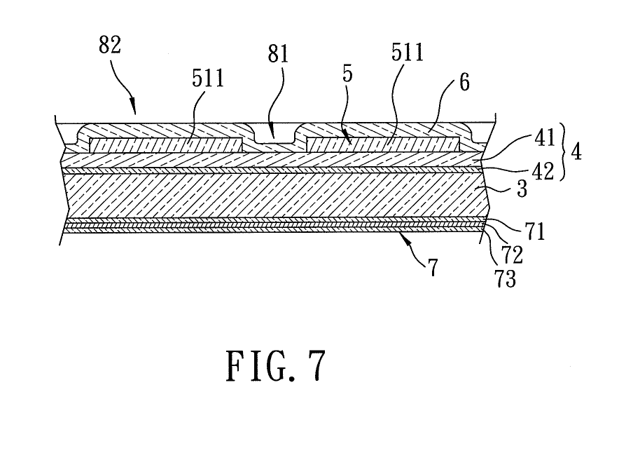

FIG. 7 illustrates the third preferred embodiment of the touch panel according to this invention. The third preferred embodiment differs from the first preferred embodiment in that the grounding layer 7 includes a transparent inner film 71 bonded to the substrate 3, a transparent metal film 72 bonded to the inner film 71, and a transparent protecting film 73 bonded to one side of the metal film 72 opposite to the inner film 71 for protecting the metal film 72 from scratching and humid environment. The inner film 71 and the protecting film 73 may be made from a transparent conductive or non-conductive material. In this embodiment, the inner film 71 and the protecting film 73 are made from a transparent conductive material, such as indium-tin-oxide (ITO), indium-zinc-oxide (IZO), aluminum zinc oxide (AZO), and combinations thereof. The metal film 72 is preferably made from silver or silver alloy, and has a film thickness of not greater than 10 nm.

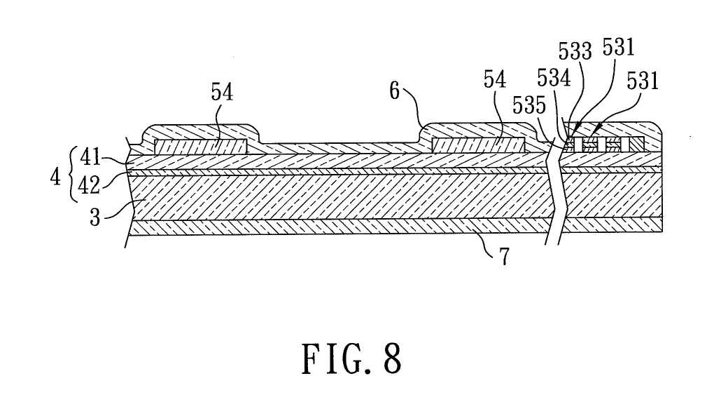

FIG. 8, in combination with FIG. 5, illustrates the fourth preferred embodiment of the touch panel according to this invention. The fourth preferred embodiment differs from the second preferred embodiment in that the each of the first and second connecting lines 53, 53′ has a first section 532, 532′ that is made from a transparent conductive material, and a second section 531, 531′ that includes transparent inner and outer conductive films 535, 533 and a metal film 534 sandwiched between the inner and outer conductive films 535, 533. The tri-layer structure of the second section 531, 531′ permits reduction of the electrical resistance of each of the first and second connecting lines 53, 53′. Alternatively, the second section 531, 531′ may be a single metal film or a single film of a transparent conductive non-metallic material.

By having the optical thicknesses of the outer anti-reflection layer 6 and the first anti-reflection film 41 to be equal to or approximately λ/4, the touch panel of this invention can generate a destructive interference and enhance the uniformity of the transmittance and thus the clarity of the touch panel.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A high transmittance touch panel comprising:
a transparent substrate; and
a transparent multi-layered structure disposed on said substrate and including transparent inner and outer anti-reflection layers and a transparent touch control layer that is sandwiched between said inner and outer anti-reflection layers and that is made from an electrically conductive material, said inner anti-reflection layer having a first anti-reflection film, at least one of said outer anti-reflection layer and said first anti-reflection film having an optical thickness sufficient for generating destructive interference among reflections from said substrate, said outer anti-reflection layer, said first anti-reflection film, and said touch control layer.

2. The high transmittance touch panel of claim 1, wherein the optical thickness of said first anti-reflection film is not greater than λ/4, where λ is the wavelength of visible light.

3. The high transmittance touch panel of claim 1, wherein the optical thickness of said outer anti-reflection layer is approximately λ/4, where λ is the wavelength of visible light.

4. The high transmittance touch panel of claim 1, further comprising a conductive grounding layer disposed on one side of said substrate opposite to said multi-layered structure.

5. The high transmittance touch panel of claim 4, wherein said grounding layer includes a transparent inner film bonded to said substrate, and a transparent metal film bonded to said inner film.

6. The high transmittance touch panel of claim 5, wherein said grounding layer further includes a transparent protecting film bonded to one side of said metal film opposite to said inner film.

7. The high transmittance touch panel of claim 2, wherein said first anti-reflection film has a refractive index not greater than that of said substrate, said outer anti-reflection layer having a refractive index not greater than that of said substrate.

8. The high transmittance touch panel of claim 7, wherein said inner anti-reflection layer further has a second anti-reflection film sandwiched between said first anti-reflection film and said substrate, said second anti-reflection film having a refractive index greater than that of said substrate, and an optical thickness not greater than λ/4.

9. The high transmittance touch panel of claim 1, wherein said touch control layer includes a plurality of spaced apart first electrodes, and a plurality of spaced apart second electrodes, each of which is operatively associated with at least an adjacent one of said first electrodes to define a capacitor therebetween.

10. The high transmittance touch panel of claim 9, wherein said touch control layer further includes a plurality of conductive first interconnecting lines, each of which interconnects two adjacent ones of said first electrodes, and a plurality of conductive second interconnecting lines, each of which interconnects two adjacent ones of said second electrodes and intersects insulatively an adjacent one of said first interconnecting lines.

11. The high transmittance touch panel of claim 1, wherein said touch control layer includes a plurality of spaced apart conductive first functional key pads, and a reference potential strip associated operatively with each of said conductive first functional key pads so as to establish a charge difference therebetween.

12. The high transmittance touch panel of claim 11, wherein said touch control layer further includes a plurality of conductive second functional key pads angularly displaced from one another, and a central pad surrounded by said second functional key pads, said reference potential strip being operatively associated with each of said second functional key pads and said central pad so as to establish a charge difference therebetween.

13. The high transmittance touch panel of claim 12, wherein said touch control layer further includes a plurality of first connecting lines, each of which extends from a respective one of said first functional key pads, and a plurality of second connecting lines, each of which extends from a respective one of said second functional key pads.

14. The high transmittance touch panel of claim 13, wherein each of said first and second connecting lines has a first section that is made from a transparent conductive non-metallic material, and a second section that includes transparent inner and outer conductive films and a metal film sandwiched between said inner and outer conductive films.

15. A capacitive-type touch panel comprising:
a transparent substrate; and
a transparent multi-layered structure disposed on said substrate and including
transparent inner and outer anti-reflection layers, said inner anti-reflection layer having a first anti-reflection film, and
a transparent touch control layer that is sandwiched between said inner and outer anti-reflection layers and that is made from an electrically conductive material, said touch control layer including a plurality of spaced apart electrodes sandwiched between said outer anti-reflection layer and said inner anti-reflection layer, said multi-layered structure defining a plurality of first regions, each of which includes a portion of said inner anti-reflection layer and a portion of said outer anti-reflection layer that covers said portion of said inner anti-reflection layer, said multi-layered structure further defining a plurality of second regions, each of which includes another portion of said inner anti-reflection layer, a respective one of said electrodes that covers said another portion of said inner anti-reflection layer, and another portion of said outer anti-reflection layer that covers said one of said first and second electrodes;
wherein at least one of said outer anti-reflection layer and said first anti-reflection film has an optical thickness sufficient for generating destructive interference among reflections from said substrate, said outer anti-reflection layer, said first anti-reflection film, and said touch control layer so as to cause reflections from said touch control layer to interfere destructively with reflections from at least one of said substrate, said outer anti-reflection layer, and said first anti-reflection film.

16. The capacitive-type touch panel of claim 15, wherein the optical thickness of said first anti-reflection film is not greater than λ/4, where λ is the wavelength of visible light.

17. The capacitive-type touch panel of claim 16, wherein the optical thickness of said outer anti-reflection layer is approximately λ/4, where λ is the wavelength of visible light.

18. The capacitive-type touch panel of claim 17, wherein said first anti-reflection film has a refractive index not greater than that of said substrate, said outer anti-reflection layer having a refractive index not greater than that of said substrate.

19. The capacitive-type touch panel of claim 18, wherein said inner anti-reflection layer further has a second anti-reflection film sandwiched between said first anti-reflection film and said substrate, said second anti-reflection film having a refractive index greater than that of said substrate, and an optical thickness not greater than λ/4.
